(19) United States
(12) Patent Application Publication
(10) Pub. No.: US 2025/0374324 A1
(43) Pub. Date: Dec. 4, 2025

(54) COMMUNICATION DEVICE AND COMMUNICATION METHOD

(71) Applicant: Realtek Semiconductor Corp., HsinChu (TW)

(72) Inventor: Yi-Lin Li, HsinChu (TW)

(73) Assignee: Realtek Semiconductor Corp., HsinChu (TW)

(21) Appl. No.: 19/221,537

(22) Filed: May 29, 2025

Related U.S. Application Data
(60) Provisional application No. 63/655,057, filed on Jun. 2, 2024.

(30) Foreign Application Priority Data
May 27, 2025 (TW) 114119835

(51) Int. Cl. H04W 74/0816; H04W 28/26; H04W 74/08

(52) U.S. Cl. CPC H04W 74/0816; H04W 28/26; H04W 74/0866

(57) ABSTRACT

A communication device includes a transmitting circuit, for transmitting at least one first packet to other communication device in at least one first interval, and for transmitting at least one of at least one first channel reservation signal and at least one second channel reservation signal to the another communication device in the at least one first interval; and a receiving circuit, for receiving at least one second packet from the other communication device in at least one second interval; wherein the at least one first interval and the at least one second interval are staggered and do not overlap with each other.

### CROSS REFERENCE TO RELATED APPLICATIONS

This application claims the benefit of U.S. Provisional Application No. 63/655,057, filed on Jun. 2, 2024. The content of the application is incorporated herein by reference.

### BACKGROUND OF THE INVENTION

### 1. Field of the Invention

The present invention relates to a communication device and a communication method used in a communication system, and more particularly, to a communication device and a communication method for reducing a number of times for performing channel detection.

### 2. Description of the Prior Art

In communication system, before two communication devices perform data transmission (e.g., transmit/receive data), one of the two communication devices performs a channel detection to ensure that a channel for the data transmission is unoccupied. As the channel detection must be performed before the data transmission, this reduces transmission efficiency (e.g. the channel detection results in a data transmission delay), and increases power consumption of the communication devices. Thus, how to reduce a number of times for performing the channel detection is an important problem to be solved.

### SUMMARY OF THE INVENTION

The present invention provides a communication device and a related communication method to solve the abovementioned problem.

A communication device according to an exemplary embodiment of the present invention comprises: a transmitting circuit, for transmitting at least one first packet to another communication device in at least one first interval, and for transmitting at least one of at least one first channel reservation signal and at least one second channel reservation signal to the other communication device in the at least one first interval; and a receiving circuit, for receiving at least one second packet from the other communication device in at least one second interval; wherein the at least one first interval and the at least one second interval are staggered and do not overlap with each other.

A communication method according to an exemplary embodiment of the present invention comprises: transmitting at least one first packet to another communication device in at least one first interval, and transmitting at least one of at least one first channel reservation signal and at least one second channel reservation signal to the other communication device in the at least one first interval; and receiving at least one second packet from the other communication device in at least one second interval; wherein the at least one first interval and the at least one second interval are staggered and do not overlap with each other.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an example of the present invention.

FIG. 2 is a schematic diagram of a communication device according to an example of the present invention.

FIG. 3 is a schematic diagram of a communication mechanism according to an example of the present invention.

FIG. 4 is a schematic diagram of a communication mechanism according to an example of the present invention.

FIG. 5 is a flowchart of a process according to an example of the present invention.

### DETAILED DESCRIPTION

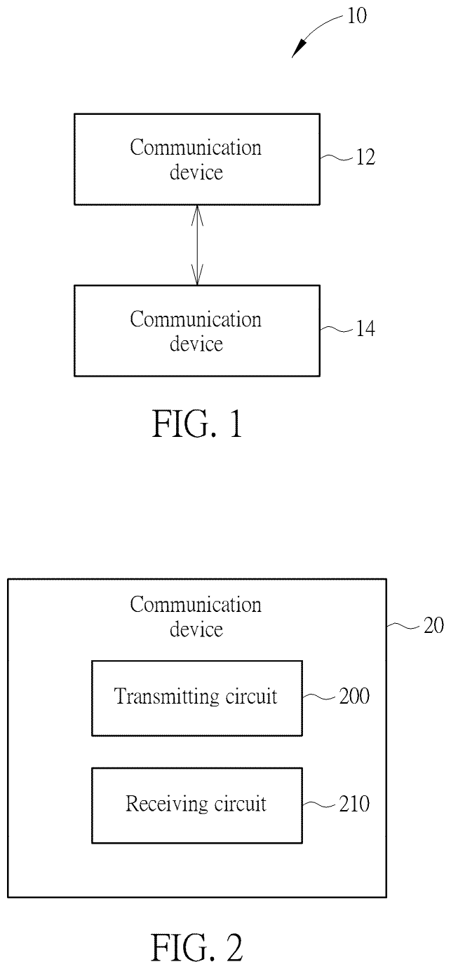

FIG. 1 is a schematic diagram of a communication system 10 according to an example of the present invention. The communication system 10 may be any communication system which uses an orthogonal frequency-division multiplexing (OFDM) technique (also termed as a discrete multi-tone modulation (DMT) technique), and is composed of communication devices 12 and 14. The communication system 10 may be any wired communication system such as an asymmetric digital subscriber line (ADSL) system, a power line communication (PLC) system or an Ethernet over coax (EOC), but is not limited herein. The communication system 10 may alternatively be any wireless communication system such as a wireless local area network (WLAN), a personal area network (PAN) (e.g. Bluetooth (BT)), a Digital Video Broadcasting (DVB) system, a Long Term Evolution (LTE) system, a Long Term Evolution-advanced (LTE-A) system or a fifth generation (5G) system, but is not limited herein.

In FIG. 1, the communication devices 12 and 14 may be mobile phones, laptops, tablet computers, smart watches, electronic books, portable computer systems, vehicles, ships, airplanes or any combination thereof. In addition, each of the communication devices 12 and 14 can be designated as either a transmitter or a receiver according to transmission direction. For example, the communication device 12 is the transmitter and the communication device 14 is the receiver. In another example, the communication device 14 is the transmitter and the communication device 12 is the receiver.

FIG. 2 is a schematic diagram of a communication device 20 according to an example of the present invention. The communication device 20 may be one of the communication devices 12 and 14, and is used to reduce a number of times for performing channel detection (e.g. Clear Channel Assessment (CCA) or Listen Before Talk (LBT)). The communication device 20 may comprise a transmitting circuit 200 and a receiving circuit 210. In detail, the transmitting circuit 200 is configured to transmit at least one first packet to another communication device in at least one first interval, and is configured to transmit at least one of at least one first channel reservation signal and at least one second channel reservation signal to the other communication device in the at least one first interval. The receiving circuit 210 is configured to receive at least one second packet from the other communication device in at least one second interval. In one example, e.g. in a time domain, the at least one first interval and the at least one second interval are staggered and do not overlap with each other. Note that the other communication device is not shown in FIG. 2, but it may be the other of the communication devices 12 and 14.

In one example, when a first interval of the at least one first interval is an initial interval in an overall interval (e.g. a connection interval), the transmitting circuit 200 transmits a first packet and a first channel reservation signal in the first interval. In one example, when a first interval of the at least one first interval is a final interval in the overall interval, the transmitting circuit 200 transmits a first packet and a second channel reservation signal in the first interval. In one example, when a first interval of the at least one first interval is neither the initial interval nor the final interval in the overall interval, the transmitting circuit 200 transmits a first packet, a first channel reservation signal and a second channel reservation signal in the first interval. In one example, the transmitting circuit 200 transmits a first packet, a first channel reservation signal and a second channel reservation signal in every first interval of the at least one first interval.

In one example, when transmitting a first packet and a first channel reservation signal in a first interval of the at least one first interval, the transmitting circuit 200 performs transmissions in the first interval in the order of the first channel reservation signal followed by the first packet, wherein transmission times for the first channel reservation signal and the first packet are adjacent (e.g. in the time domain). In one example, the transmission times for the first channel reservation signal and the first packet being adjacent (e.g. in the time domain) represents that a first gap between the transmission times for the first channel reservation signal and the first packet is smaller than a first threshold. In one example, when transmitting a first packet and a second channel reservation signal in a first interval of the at least one first interval, the transmitting circuit 200 performs transmissions in the first interval in the order of the first packet followed by the second channel reservation signal, wherein transmission times for the first packet and the second channel reservation signal are adjacent (e.g. in the time domain). In one example, the transmission times for the first packet and the second channel reservation signal being adjacent (e.g. in the time domain) represents that a second gap between the transmission times for the first packet and the second channel reservation signal is smaller than a second threshold. In one example, when transmitting a first packet, a first channel reservation signal and a second channel reservation signal in a first interval of the at least one first interval, the transmitting circuit 200 performs transmissions in the first interval in the order of the first channel reservation signal, followed by the first packet and then the second channel reservation signal, wherein transmission times for the first channel reservation signal and the first packet are adjacent (e.g. in the time domain), and transmission times for the first packet and the second channel reservation signal are adjacent (e.g. in the time domain). In one example, the transmission times for the first channel reservation signal and the second channel reservation signal may be the same or different. In one example, the first threshold and the second threshold are determined according to a usage scenario of the communication device 20, but are not limited herein. In one example, the first threshold and/or the second threshold are a fixed value (s). In one example, the first threshold and/or the second threshold are variables. In one example, the first threshold and the second threshold may be the same or different.

In one example, a gap between a first interval of the at least one first interval and a next interval is smaller than a sum of a third threshold and a first transmission time. In one example, the next interval is a second interval of the at least one second interval. In one example, the first transmission time is a transmission time for a first channel reservation signal. In one example, a gap between a first interval of the at least one first interval and a previous interval is smaller than a sum of the third threshold and a second transmission time. In one example, the previous interval is a second interval of the at least one second interval. In one example, the second transmission time is a transmission time for a second channel reservation signal. In one example, the third threshold is defined in a communication standard.

In one example, the at least one first interval and the at least one second interval are comprised in the overall interval. In one example, each packet of the at least one first packet and the at least one second packet may has a same transmission time. In one example, each first channel reservation signal in the at least one first channel reservation signal has a same transmission time. In one example, each second channel reservation signal in the at least one second channel reservation signal has a same transmission time.

In one example, the communication device 20 further comprises a detecting circuit (not shown in FIG. 2). The detecting circuit is coupled to the transmitting circuit 200 and the receiving circuit 210. The detecting circuit detects a channel (e.g. performs the CCA or the LBT for the channel, but not limited herein) before the overall interval to generate a detection result. In one example, the detection result may be “success” and “failure”. In one example, the detection result “success” represents that the detected channel is not occupied by another communication device. In one example, the detection result “failure” represents that the detected channel is occupied by another communication device.

In one example, the transmitting circuit 200 transmits the at least one first packet to the other communication device in the at least one first interval of the detected channel and transmits at least one of the at least one first channel reservation signal and the at least one second channel reservation signal to the other communication device in the at least one first interval of the detected channel, in response to the detection result “success”. In one example, the receiving circuit 210 receives the at least one second packet from the other communication device in the at least one second interval of the detected channel, in response to the detection result “success”. In one example, the transmitting circuit 200 does not transmit the at least one first packet, the at least one first channel reservation signal and the at least one second channel reservation signal in the detected channel, in response to the detection result “failure”. In one example, the receiving circuit 210 does not receive the at least one second packet from the other communication device, in response to the detection result “failure”.

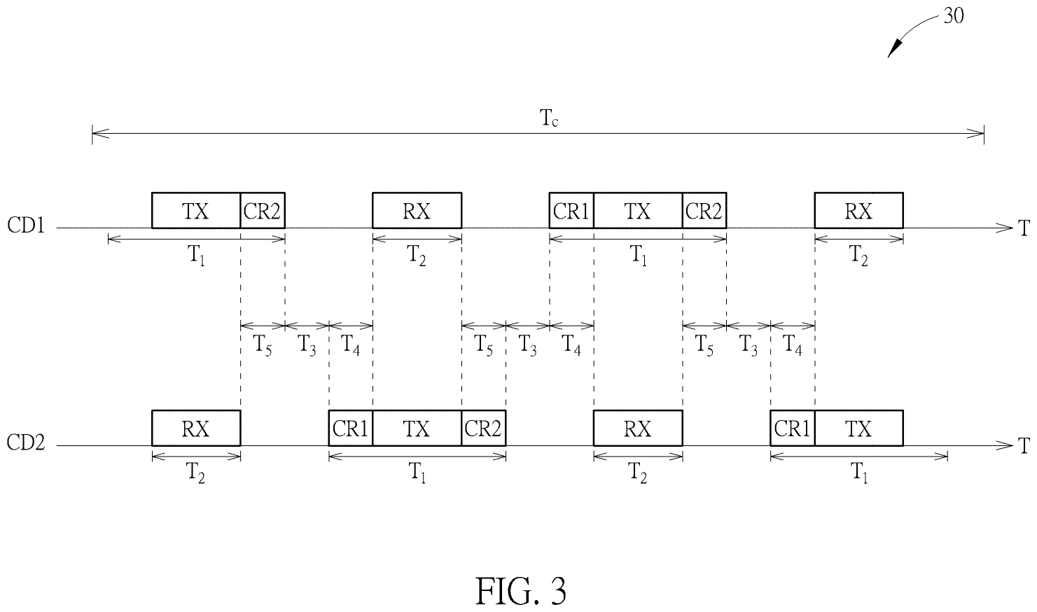

FIG. 3 is a schematic diagram of a communication mechanism 30 according to an example of the present invention. In FIG. 3, communication devices CD1 and CD2 communicate with each other. The communication devices CD1 and CD2 may both be the communication device 20 illustrated in FIG. 2. For convenience of explanation, the communication devices CD1 and CD2 correspond to a time dimension T, respectively. In an overall interval T_{c}, each of the communication devices CD1 and CD2 has multiple (e.g. 2) intervals T₁ and multiple (e.g. 2) intervals T₂. In the time dimension T, the intervals T₁ and the intervals T₂ are staggered and do not overlap with each other. The intervals T₁ are used for transmissions, and the intervals T₂ are used for receptions. Since an initial interval of the communication device CD1 in the overall interval T_{c} is the interval T₁, the communication device CD1 transmits a packet TX and a channel reservation signal CR2 to the communication device CD2 in the initial interval T₁. The communication device CD1 transmits a first channel reservation signal CR1, a packet TX and a channel reservation signal CR2 to the communication device CD2 in the other interval T₁, and receives a packet RX from the communication device CD2 in each of the intervals T₂. Since a final interval of the communication device CD2 in the overall interval T_{c} is the interval T₁, the communication device CD2 transmits a first channel reservation signal CR1 and a packet TX to the communication device CD1 in the final interval T₁. The communication device CD2 transmits a first channel reservation signal CR1, a packet TX and a channel reservation signal CR2 to the communication device CD1 in the other interval T₁, and receives a packet RX from the communication device CD1 in each of the intervals T₂.

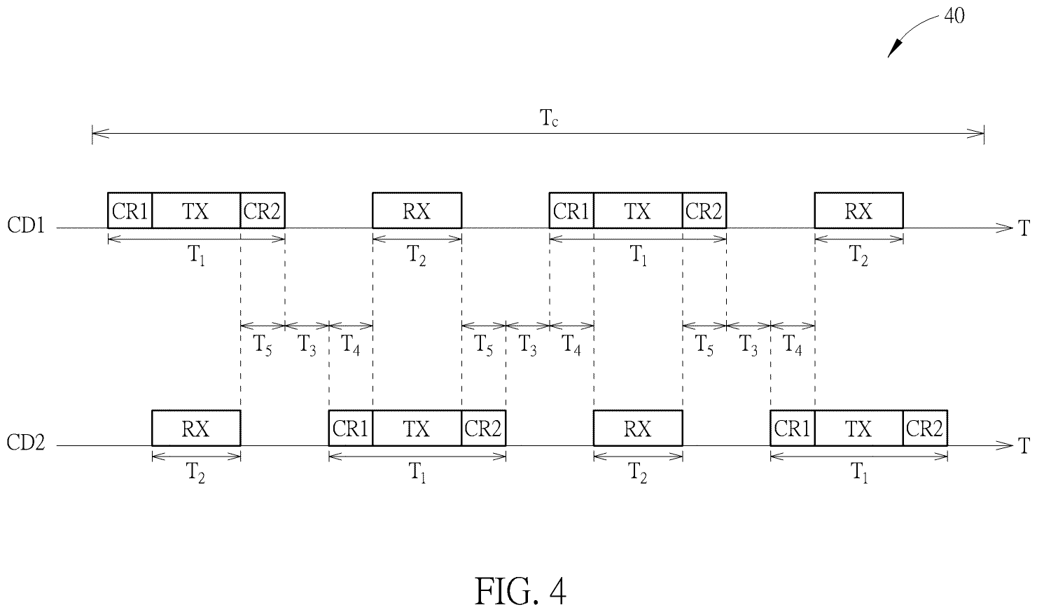

FIG. 4 is a schematic diagram of a communication mechanism 40 according to an example of the present invention. In FIG. 4, communication devices CD1 and CD2 communicate with each other. The communication devices CD1 and CD2 may both be the communication device 20 illustrated in FIG. 2. For convenience of explanation, the communication devices CD1 and CD2 correspond to a time dimension T, respectively. In an overall interval T_{c}, each of the communication devices CD1 and CD2 has multiple (e.g. 2) intervals T₁ and multiple (e.g. 2) intervals T₂. In the time dimension T, the intervals T₁ and the intervals T₂ are staggered and do not overlap with each other. The intervals T₁ are used for transmissions, and the intervals T₂ are used for receptions. The communication device CD1 transmits a first channel reservation signal CR1, a packet TX and a channel reservation signal CR2 to the communication device CD2 in each of the intervals T₁, and receives a packet RX from the communication device CD2 in each of the intervals T₂. The communication device CD2 transmits a first channel reservation signal CR1, a packet TX and a channel reservation signal CR2 to the communication device CD1 in each of the intervals T₁, and receives a packet RX from the communication device CD1 in each of the intervals T₂.

In FIGS. 3-4, the packet TX transmitted by the communication device CD1 is equivalent to the packet RX received by the communication device CD2, and the packet RX received by the communication device CD1 is equivalent to the packet TX transmitted by the communication device CD2. Transmission times for the packets TX and RX are the same (i.e. the interval T₂). A transmission time for the first channel reservation signal CR1 is an interval T₄, and a transmission time for the second channel reservation signal CR2 is an interval T₅. The interval T₄ may be the same or different from the interval T₅. A gap between an interval T₁ and a next interval T₂ (if any) is a sum of the interval T₃ and the interval T₄. A gap between an interval T₁ and a previous interval T₂ (if any) is a sum of the interval T₃ and the interval T₅. The interval T₃ is smaller than a threshold. Thus, before performing a switching (e.g. a transmission-to-reception switching or a reception-to-transmission switching), the communication devices CD1 and CD2 do not need to detect channels, and can continue to occupy the channel in use for transmitting/receiving packets. In addition, a gap between an interval T₁ and an interval T₂ (e.g. the sum of the interval T₃ and the interval T₄ or the sum of the interval T₃ and the interval T₅) is sufficient for the communication devices CD1 and CD2 to perform the switching.

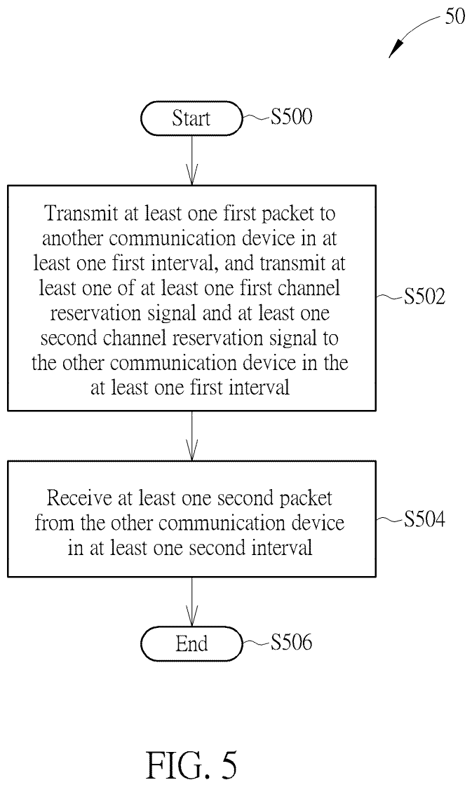

Operations of the communication device 20 in the above examples can be summarized into a process 50 shown in FIG. 5, which reduces a number of times for performing channel detection (e.g. the CCA or the LBT). The process 50 includes the following steps:
Step S500: Start.
Step S502: Transmit at least one first packet to another communication device in at least one first interval, and transmit at least one of at least one first channel reservation signal and at least one second channel reservation signal to the other communication device in the at least one first interval.
Step S504: Receive at least one second packet from the other communication device in at least one second interval.
Step S506: End.

The process 50 is used for illustrating the operations of the communication device 20. A detailed description and variations of the process 50 can be known by referring to the above description, and are therefore not narrated herein. In process 50, the Steps S502 and Step S504 may be performed reversely. That is, the communication device may receive the at least one second packet first, and then transmit the at least one first packet, at least one first channel reservation signal and/or at least one second channel reservation signal.

The terms “first”, “second” and “third” described above are used to distinguish the relevant statements, and do not limit the order of the relevant statements. The term “comprise” described above may be replaced by the term “be”. The term “when” described above may be replaced by the term “in response to”. The term “detect” described above may be replaced by one of the terms “monitor”, “sense” and “obtain”.

It should be noted that there are various possible realizations of the communication device 20 and the circuits included in the communication device 20 (e.g. the transmitting circuit 200, the receiving circuit 210 and the detecting circuit). For example, the circuits in the device mentioned above may be integrated into one or more circuits. In addition, the communication system 10, the communication device 20 and the circuits in the communication device 20 may be realized by hardware (e.g., circuits), software, firmware (known as a combination of a hardware device, computer instructions and data that reside as read-only software on the hardware device), an electronic system or a combination of the devices mentioned above, but are not limited herein.

To sum up, the present invention provides a communication device and a communication method. The communication device transmits channel reservation signal(s) before/after transmitting a packet, so that a gap between an interval for transmission and an interval for reception is shortened. Since the shortened gap is smaller than a value (e.g. a sum of a threshold and a transmission time for a channel reservation signal), the communication device does not need to perform the channel detection, and continues to occupy the channel in use for transmitting/receiving packets. Thus, a number of times for the communication device performing the channel detection can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a transmitting circuit, for transmitting at least one first packet to another communication device in at least one first interval, and for transmitting at least one of at least one first channel reservation signal and at least one second channel reservation signal to the other communication device in the at least one first interval; and
a receiving circuit, for receiving at least one second packet from the other communication device in at least one second interval;
wherein the at least one first interval and the at least one second interval are staggered and do not overlap with each other.

2. The communication device of claim 1, wherein when a first interval of the at least one first interval is an initial interval in an overall interval, the transmitting circuit transmits a first packet and a first channel reservation signal in the first interval.

3. The communication device of claim 1, wherein when a first interval of the at least one first interval is a final interval in an overall interval, the transmitting circuit transmits a first packet and a second channel reservation signal in the first interval.

4. The communication device of claim 1, wherein when a first interval of the at least one first interval is neither an initial interval nor a final interval in an overall interval, the transmitting circuit transmits a first packet, a first channel reservation signal and a second channel reservation signal in the first interval.

5. The communication device of claim 1, wherein the transmitting circuit transmits a first packet, a first channel reservation signal and a second channel reservation signal in every first interval of the at least one first interval.

6. The communication device of claim 1, wherein when transmitting a first packet and a first channel reservation signal in a first interval of the at least one first interval, the transmitting circuit performs transmissions in the first interval in the order of the first channel reservation signal followed by the first packet; and transmission times for the first channel reservation signal and the first packet are adjacent.

7. The communication device of claim 1, wherein when transmitting a first packet and a second channel reservation signal in a first interval of the at least one first interval, the transmitting circuit performs transmissions in the first interval in the order of the first packet followed by the second channel reservation signal; and transmission times for the first packet and the second channel reservation signal are adjacent.

8. The communication device of claim 1, wherein when transmitting a first packet, a first channel reservation signal and a second channel reservation signal in a first interval of the at least one first interval, the transmitting circuit performs transmissions in the first interval in the order of the first channel reservation signal, followed by the first packet and then the second channel reservation signal; transmission times for the first channel reservation signal and the first packet are adjacent; and transmission times for the first packet and the second channel reservation signal are adjacent.

9. The communication device of claim 1, wherein a gap between a first interval of the at least one first interval and a next interval is smaller than a sum of a threshold and a first transmission time.

10. The communication device of claim 9, wherein the next interval is a second interval of the at least one second interval, and the first transmission time is a transmission time for a first channel reservation signal.

11. The communication device of claim 1, wherein a gap between a first interval of the at least one first interval and a previous interval is smaller than a sum of a threshold and a second transmission time.

12. The communication device of claim 11, wherein the previous interval is a second interval of the at least one second interval, and the second transmission time is a transmission time for a second channel reservation signal.

13. A communication method, comprising:
transmitting at least one first packet to another communication device in at least one first interval, and transmitting at least one of at least one first channel reservation signal and at least one second channel reservation signal to the other communication device in the at least one first interval; and
receiving at least one second packet from the other communication device in at least one second interval;
wherein the at least one first interval and the at least one second interval are staggered and do not overlap with each other.

14. The communication method of claim 13, wherein when a first interval of the at least one first interval is neither an initial interval nor a final interval in an overall interval, the transmitting circuit transmits a first packet, a first channel reservation signal and a second channel reservation signal in the first interval.

15. The communication method of claim 13, wherein when transmitting a first packet and a first channel reservation signal in a first interval of the at least one first interval, the transmitting circuit performs transmissions in the first interval in the order of the first channel reservation signal followed by the first packet; and transmission times for the first channel reservation signal and the first packet are adjacent.

16. The communication method of claim 13, wherein when transmitting a first packet and a second channel reservation signal in a first interval of the at least one first interval, the transmitting circuit performs transmissions in the first interval in the order of the first packet followed by the second channel reservation signal; and transmission times for the first packet and the second channel reservation signal are adjacent.

17. The communication method of claim 13, wherein when transmitting a first packet, a first channel reservation signal and a second channel reservation signal in a first interval of the at least one first interval, the transmitting circuit performs transmissions in the first interval in the order of the first channel reservation signal, followed by the first packet and then the second channel reservation signal; transmission times for the first channel reservation signal and the first packet are adjacent; and transmission times for the first packet and the second channel reservation signal are adjacent.

18. The communication method of claim 13, wherein a gap between a first interval of the at least one first interval and a next interval is smaller than a sum of a threshold and a first transmission time.

19. The communication method of claim 18, wherein the next interval is a second interval of the at least one second interval, and the first transmission time is a transmission time for a first channel reservation signal.

20. The communication method of claim 13, wherein a gap between a first interval of the at least one first interval and a previous interval is smaller than a sum of a threshold and a second transmission time.
